(19) United States
(12) Patent Application Publication
(10) Pub. No.: US 2014/0210211 A1
(43) Pub. Date: Jul. 31, 2014

(54) INEXPENSIVE FLOATING HORIZONTAL AND VERTICAL AXIS WATER TURBINES MOUNTED ON BRIDGE AND OTHER STRUCTURES TO CONVERT HYDROKINETIC ENERGY TO ELECTRIC ENERGY

(71) Applicant: Paul M. Swamidass, Auburn, AL (US)

(72) Inventor: Paul M. Swamidass, Auburn, AL (US)

(21) Appl. No.: 14/224,673

(22) Filed: Mar. 25, 2014

Related U.S. Application Data
(63) Continuation-in-part of application No. 13/429,375, filed on Mar. 24, 2012, now Pat. No. 8,459,020.

(51) Int. Cl. F03B 17/06; F03B 13/26; F03B 13/00

(52) U.S. Cl. CPC F03B 17/063; F03B 13/00; F03B 13/264
USPC 290/54

(57) ABSTRACT

Water turbines on the surface of moving water can capture hydrokinetic energy (HKE) from waves, currents and other flows. This invention uses a novel system to keep the horizontal-axis water turbines (WAWT) and vertical-axis water turbines (VAWT) operating on the surface of water by mounting them on bridge columns, seawalls, oil rigs, piers and similar structures to capture energy from the moving water next to said structures.

### CROSS-REFERENCE TO RELATED APPLICATIONS AND CLAIMS TO PRIORITY

This is a continuation-in-part of, and claims priority commonly assigned to U.S. patent application Ser. No. 13/429,375 filed on Mar. 24, 2012, now U.S. Pat. No. 8,459,020, issued Jun. 11, 2013; application PCT/US2013/031334 filed on Mar. 14, 2013 filed through the USPTO, the receiving office; USPTO Application 13/964038 filed on Aug. 10, 2012; and U.S. patent application Ser. No. 13/984,498 filed on Aug. 8, 2013. The entire disclosure of which is incorporated herein by reference.

### BACKGROUND OF THE INVENTION

### Prior Art

Moving water in the ocean, sea and rivers offer plenty of energy but the technology to harvest HKE energy from water is still in the infant stages. U.S. patent application Ser. No. 13/429,375 filed on Mar. 24, 2012, and now issued U.S. Pat. No. 8,459,020, and application PCT/US2013/031334 teach the following about existing technologies for HKEC systems: they require expensive investment in civil and mechanical systems to retain these systems in boisterous water during severe weather. Therefore HKEC systems require prohibitively expensive civil and mechanical structures to retain them during storms.

Highways and railroads over water are built on extremely strong columns that are capable of withstanding fiercest wind and water forces. These columns serve as dual-use inexpensive mounts for innovative HKEC systems of this invention. Further, this invention overcomes the well-known inefficiencies and immaturity of the submerged water-energy conversion technologies in existence today. This invention overcomes inefficiencies and immaturity in existing HKEC technologies and systems by adapting advanced, efficient wind turbine-generators for wave and water energy conversion without submerging the electric generators in the water.

### GENERAL DESCRIPTION OF THE INVENTION

Bridge columns, seawalls, piers, oil drilling rigs, stationary boats, and similar structures in and around water offer multiple opportunities to harvest HKE from water. The inventions listed below are to be of the appropriate scale to prevent overloading of the bridge columns beyond their designed strength. The embodiments below can be mounted on bridge-supporting columns already in use (retrofitted) or designed in the future as part of new bridge structures over water. Further, this invention adapts highly efficient wind turbine-generators for energy production from moving water.

### BRIEF DESCRIPTION OF DRAWINGS OF ONE EMBODIMENT

FIG. 1: A side view from the upstream side of the flowing water. Floating horizontal-axis water turbine (HAWT), with turbine axis perpendicular to the flowing/moving water, suspended on the surface of the water using cable, pulley and counterweights from a structure including bridge columns in the water, while allowing the water turbine to slide up and down the structure as the water level rises or drops.

FIG. 2: A cross-sectional side view of the HAWT turbine showing only the axial float and two opposing blades.

FIG. 3: A cross-sectional side view of HAWT turbine from the water side looking towards the support structure behind the turbine, the electric generator is positioned above the water with respect to the turbine in the turbine-generator assembly.

FIG. 4: A view from the upstream side of the flowing water. Floating vertical-axis water turbine (VAWT) suspended on the surface of the water using cable, pulley and counterweights from a structure in or adjacent to flowing water, allowing the water turbine to slide up and down the structure as the water level rises or drops.

FIG. 5: A view from the upstream side of the flowing water. Shows a floating horizontal-axis wind turbine, similar in every regard to the HAWT in FIG. 1, except that it is hinged on the end nearest to the supporting structure thereby permitting the turbine-generator assembly to be tilted out of the water by the cable for maintenance or during rough weather.

FIG. 6: A view from the upstream side of the flowing water. A long floating HAWT suspended in water by cables, pulleys and counterweights anchored in two adjacent bridge or other structures in water.

### DETAILED DESCRIPTION OF DRAWINGS OF ONE EMBODIMENT

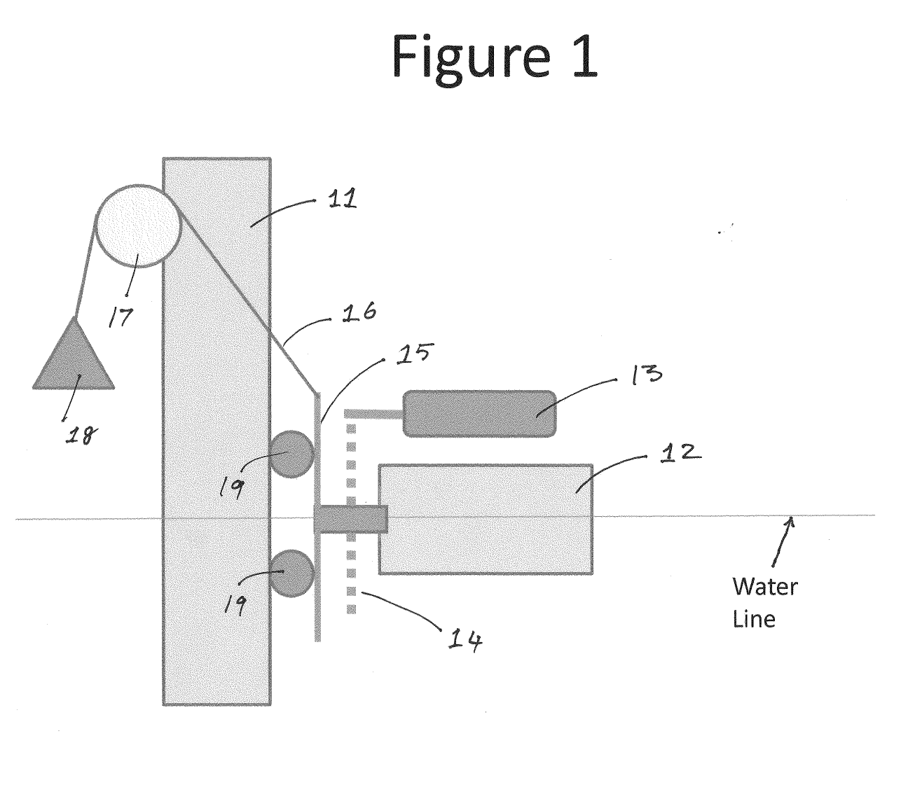

FIG. 1 is a side view from the upstream side of the turbine 12, mounted on an assembly 15, which slides on rollers 19 up and down the bridge or other structures 11. The electric generator 13 is positioned above the water turbine 12 to stay clearly above the water surface. The water turbine transfers rotary power to the generator through the gearing system 14 so that the generator turns at a much higher rpm than the water turbine below. The rope 16, pulley 17 and weight 18 keep the turbine floating on the surface of the water, when the water level rises or falls.

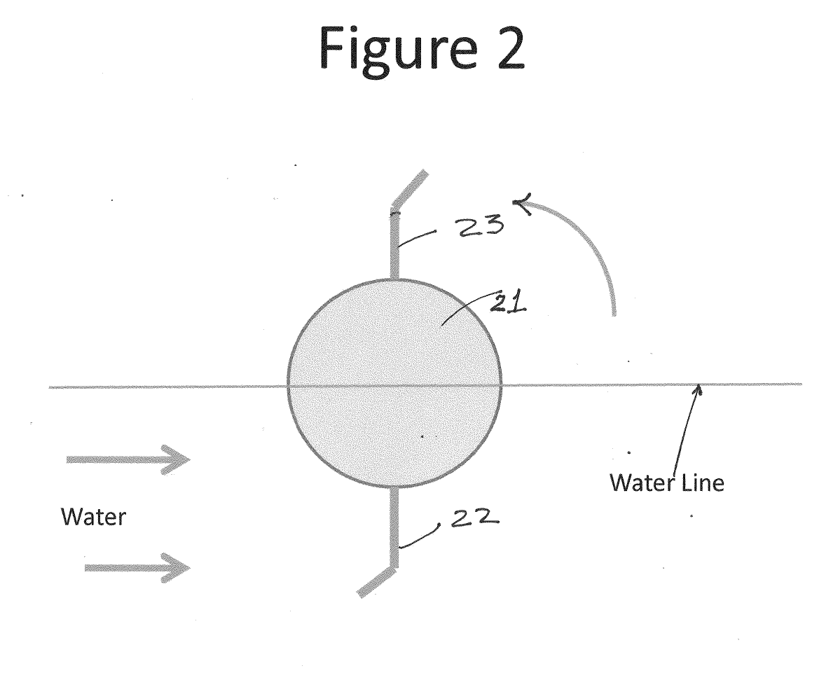

FIG. 2 is a cross-sectional side view of the HAWT turbine showing the circular hollow hub 21 that serves as a float as well, and two blades 22 and 23. The figure shows moving water turns the turbine in the counterclockwise direction. The figure shows the turbine hub 21 floating on the surface of water, while the lower blade dips fully into the water allowing the flowing water to turn the turbine. The blade 23 above the hub 21 is fully out of the water as it turns counterclockwise in the air to minimize the drag on it. This invention takes advantage of the minimal drag on the blades turning above the water line (density of water is about 784 times greater than air).

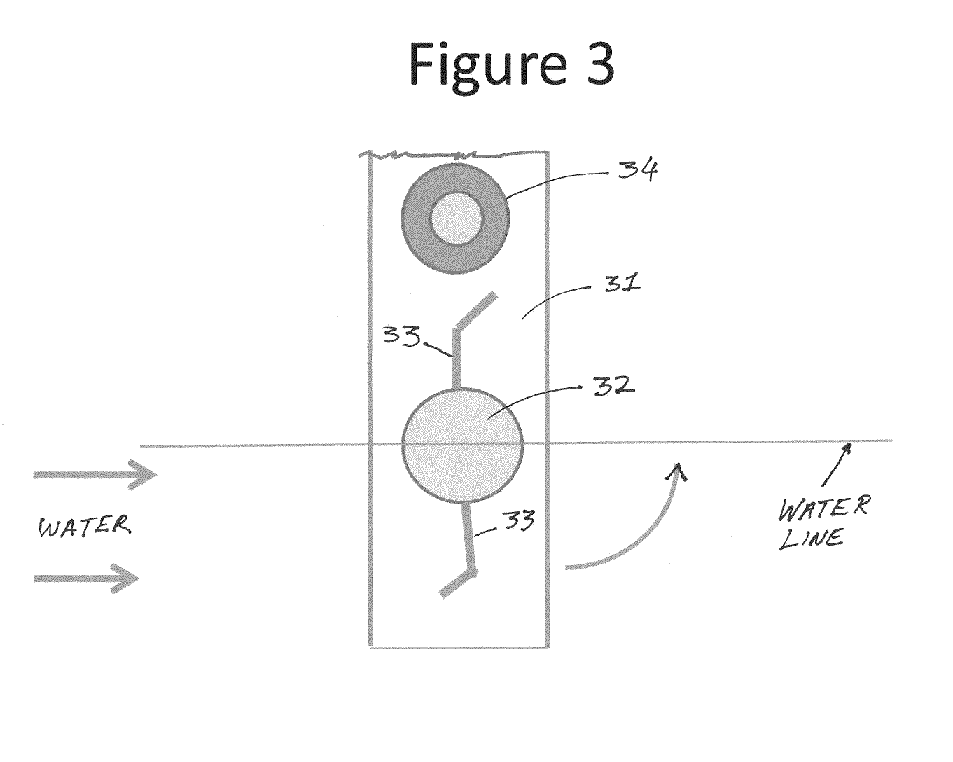

FIG. 3 is a cross-sectional side view from the water towards the structure 31 supporting the turbine 32. The figure shows the relative position of the electric generator 34 above the turbine 32 in the turbine-generator assembly such that the electric generator is clearly positioned above the water. Lower blade 33 is under water capturing the energy in the moving water, while the upper blade 33 is above the water moving counterclockwise in the air with relatively negligible drag compared to the blade moving under water for maximizing turbine efficiency.

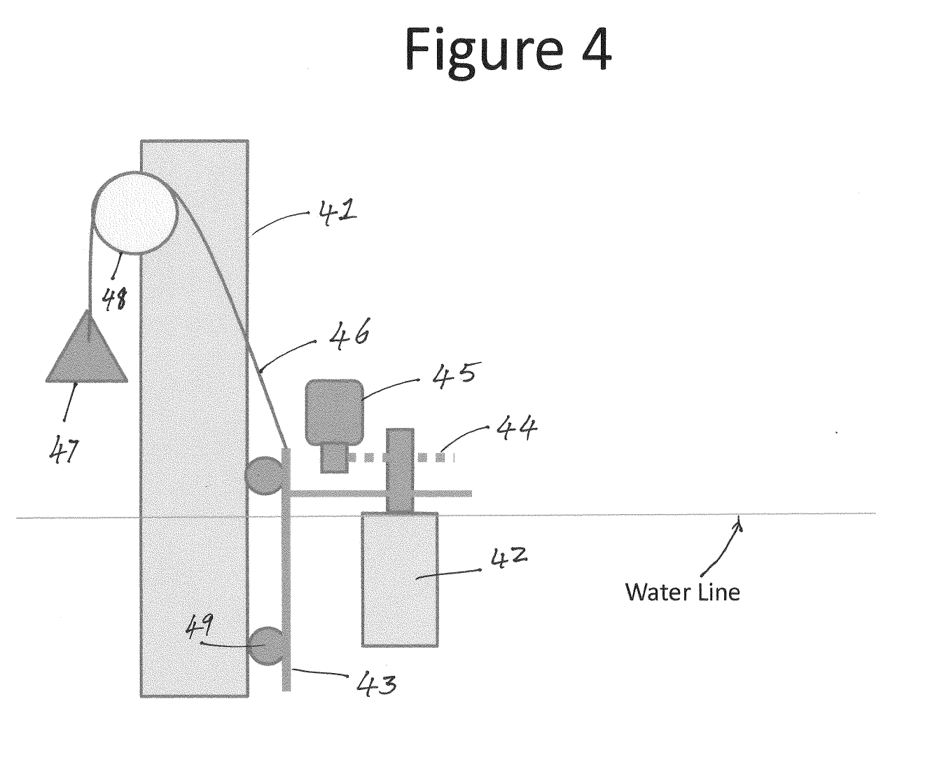

FIG. 4 shows a vertical-axis water turbine (VAWT) 42 mounted on a bridge column or other structure 41 near flowing water much like the HAWT in FIG. 1. The turbine-generator assembly 43 moves up and down the support structure 41 on rollers 49. The turbine drives the electric generator 45 at a much higher rpm through a gearing system 44. The rope 46, pulley 48 and weight 47 keeps the turbine floating at the surface of the water.

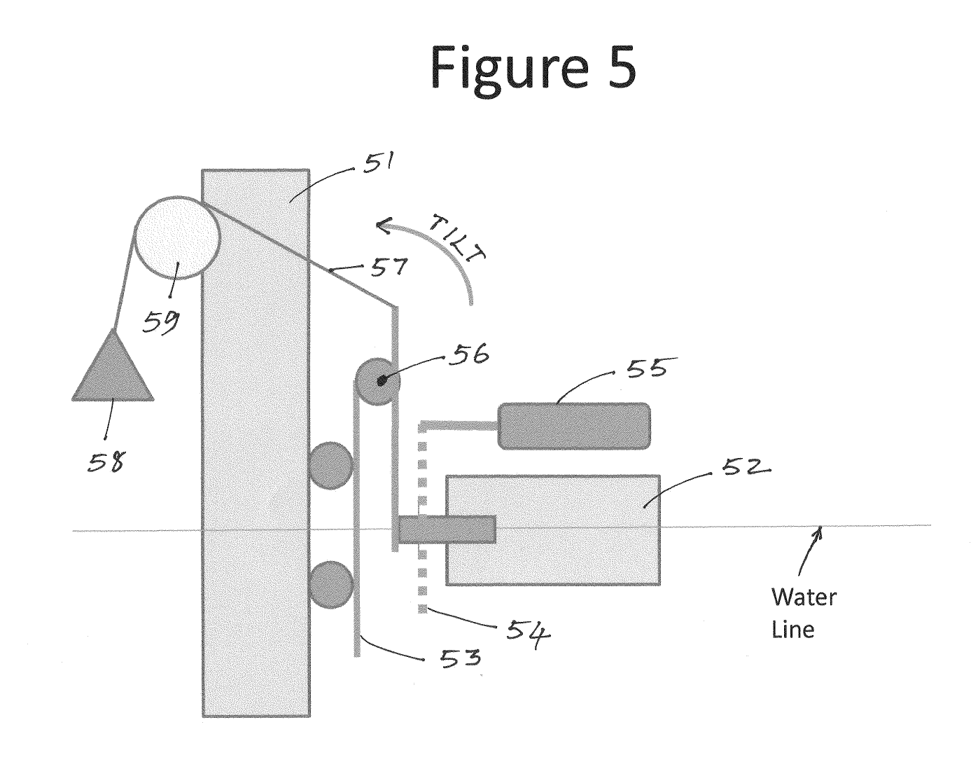

FIG. 5 is similar to FIG. 1 except that turbine 52 can be tilted out of the water around the fulcrum/hinge 56 for maintenance or during rough weather by a system of rope 57, pulley 59 and weight 58 anchored to the column. The turbine 52 drives the electric generator 55 at a much higher rpm through the gearing system 54.

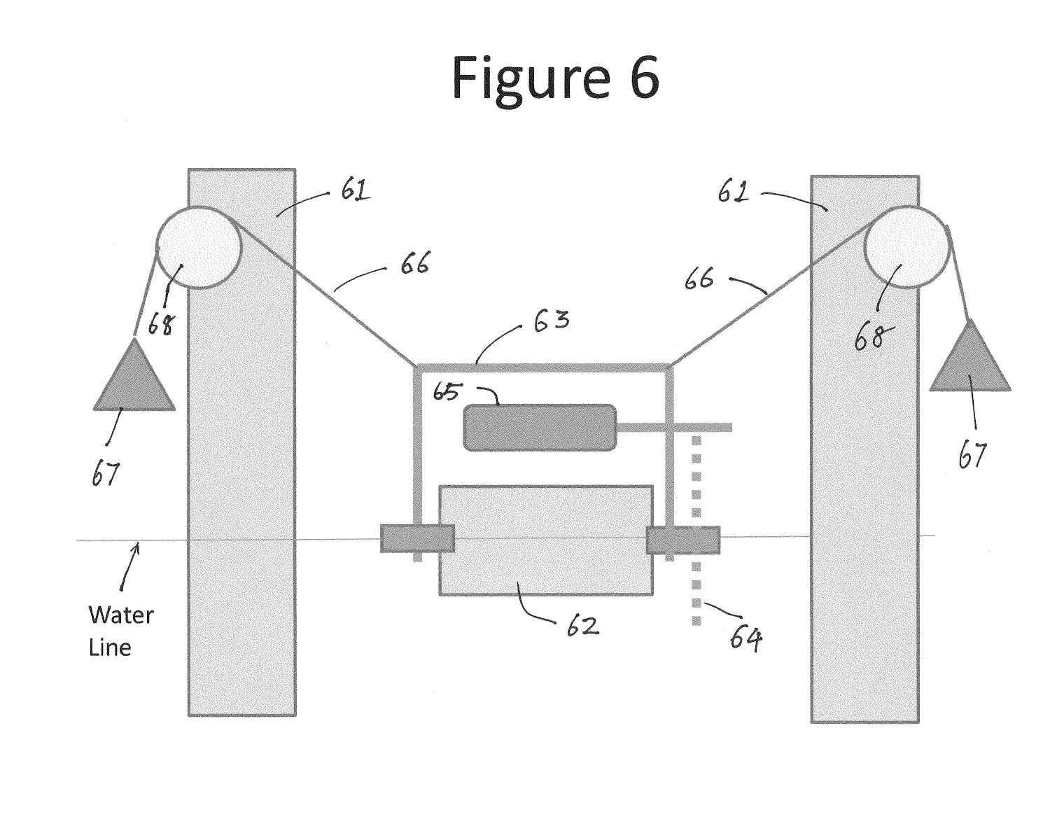

FIG. 6 shows how two support structures or bridge columns 61 could be used to support an HAWT 62 on the surface of the water. In this deployment, the turbine could be much longer than the turbines shown in FIGS. 1 and 5, which are supported by a structure on one side only. Longer turbines carrying blades of larger surface area could produce more electric energy than shorter turbines with blades of lesser surface area. In this figure, turbine 62 turns the generator 65 at a much higher rpm through a gearing system 64. Turbine-generator assembly 63 is held up by two sets of cables 66, pulleys 68 and weighs 67.

Numerous variations of the apparatus of the present invention can be made. Thus, the intention of this invention is to cover any modification or variation if they come within the scope of the appended claims and their equivalents.

1. A system for converting hydrokinetic energy in waves, water currents and in tidal flows comprising:
a. at least one bridge support column, seawall or a sturdy structure disposed in a body of water;
b. at least one horizontal-axis water turbine (HAWT) that can convert hydrokinetic energy to rotary motion;
c. a hollow turbine hub that keeps the turbine afloat on the surface of the water and the turbine axis lies perpendicular to the direction of the flowing or moving water;
d. a vertically slidable rigid assembly consisting of at least one water turbine that turns at least one electric generator at a higher rpm than the water turbine itself through a gearing system; further, the electric generator that is:
i. a low-rpm kind developed for wind turbines;
ii. a high efficiency kind developed for wind turbines.
e. each water turbine-comprising a plurality of blades circumferentially spaced around the turbine hub;
f. a system of cable, pulley and weight anchored to the bridge column or other structures well above the water line for holding up the vertically slidable turbine-generator assembly in claim 1d such that:
i. the bottom half of the water turbine is submerged in water and the other half is above the water level;
ii. the top half of the water turbine that is above the water level minimizes the drag on the turbine blades while turning in the air above the water level for maximizing turbine efficiency;
iii. the electric generator is always held above the water.

2. The system for converting hydrokinetic energy in waves, water currents and in tidal flows of claim 1, further comprising:
a. two support columns or support structures disposed in a body of water;
b. at least one HAWT, with a long turbine axis, that cannot be supported by one column or structure alone;
c. a turbine whose axis lies perpendicular to the flowing or moving water;
d. one support columns or structures at either end of the turbine axis;
e. a pair of pulleys, cables and weights anchored to the two support columns so that:
i. the two cable ends are attached to the two ends of the turbine-generator assembly to hold the bottom half of the turbine immersed in the water;
ii. the turbine rises and falls with the water level.

3. The system for converting hydrokinetic energy in waves, water currents and tidal flows of claim 1, further comprising:
a. a hinged turbine-generator assembly that holds the HAWT, gears and an electric generator;
b. a system of cable, pulley and weights that can tilt the turbine-generator assembly out of the water during rough weather or for maintenance.

4. The system for converting hydrokinetic energy in waves, water currents and tidal flows of claim 1, further comprising:
a. an efficient vertical-axis water turbine (VAWT), fully immersed in the water near the water surface, replaces the HAWT in the turbine-generator assembly in claim 1.
